(19) United States
(12) Patent Application Publication
(10) Pub. No.: US 2026/0277945 A1
(43) Pub. Date: Sep. 17, 2026

(54) ADDITIONAL INSTRUCTION UPDATE METHOD AND ADDITIONAL INSTRUCTION UPDATE SYSTEM

(71) Applicant: Hitachi-GE Nuclear Energy, Ltd., Ibaraki (JP)

(72) Inventors: Fumimaro Odakura, Tokyo (JP); Masao Yamashiro, Tokyo (JP); Satoshi Kuwamoto, Tokyo (JP)

(73) Assignee: Hitachi-GE Nuclear Energy, Ltd., Ibaraki (JP)

(21) Appl. No.: 19/191,031

(22) Filed: Apr. 28, 2025

(30) Foreign Application Priority Data
Jun. 7, 2024 (JP) 2024-093266

(51) Int. Cl. G06F 16/332; G06F 11/07; G06F 16/3329

(52) U.S. Cl. CPC G06F 16/3326; G06F 11/0787; G06F 16/3329; G06F 2201/80

(57) ABSTRACT

An additional instruction update method includes: data registration processing of pre-registering a query generation instruction, a schema of a search target database, and a candidate pattern for an additional instruction for creating a prompt; query generation processing of generating a query by inputting the prompt to a language model; query execution processing of executing the query with respect to the search target database to acquire a query execution result and an error log; query history accumulation processing of acquiring feedback for the query execution result, and accumulating a query history in which the prompt, the query, the query execution result, the error log, and the feedback are associated with each other by identification information; and additional instruction update processing of updating the additional instruction by determining whether to describe the candidate pattern in the prompt using the query history.

### BACKGROUND

### Technical Field

The present invention relates to an additional instruction update method and an additional instruction update system.

### Related Art

There is a technology for generating a query result using a knowledge graph in an artificial intelligence chatbot. For example, Patent Literature 1 describes a technology in which query characteristics are mapped to basic elements of a knowledge graph in an artificial intelligence chatbot.

### CITATION LIST

### Patent Literature

Patent Literature 1: JP 2022-546031 A

### SUMMARY

Patent Literature 1 does not mention a prompt to be input to the artificial intelligence chatbot equipped with a language model. Therefore, when an error occurs during query execution or an error occurs in a query result, this problem cannot be solved.

An object of the present invention is to provide an additional instruction update method and an additional instruction update system capable of solving an error during query execution and an error in a query result.

In order to solve the aforementioned problem, for example, the configurations set forth in the claims are adopted.

The present application includes a plurality of means for solving the aforementioned problem, and an example thereof is a method for updating an additional instruction described in a prompt in generating a query using a language model, the method including: data registration processing of pre-registering a query generation instruction, a schema of a search target database, and a candidate pattern for the additional instruction for creating the prompt; query generation processing of generating the query by inputting the prompt to the language model; query execution processing of executing the query with respect to the search target database to acquire a query execution result and an error log; query history accumulation processing of acquiring feedback for the query execution result, and accumulating a query history in which the prompt, the query, the query execution result, the error log, and the feedback are associated with each other by identification information; and additional instruction update processing of updating the additional instruction by determining whether to describe the candidate pattern in the prompt using the query history.

According to the present invention, even if an error occurs during query execution or an error occurs in a query result when generating a query using a language model, it is possible to resolve the error.

Problems, configurations, and effects other than those described above will be apparent from the following description of embodiments.

### BRIEF DESCRIPTION OF DRAWINGS

FIG. 1 is a block diagram illustrating an example of a configuration of an additional instruction update system according to an embodiment of the present invention;

FIG. 2 is a flowchart illustrating an example of data registration processing performed by a data registration unit according to an embodiment of the present invention;

FIG. 3 is a flowchart illustrating an example of query generation processing performed by a query generation unit according to an embodiment of the present invention;

FIG. 4 is a flowchart illustrating an example of query execution processing performed by a query execution unit according to an embodiment of the present invention;

FIG. 5 is a flowchart illustrating an example of query history accumulation processing performed by a query history accumulation unit according to an embodiment of the present invention;

FIG. 6 is a flowchart illustrating an example of additional instruction update processing performed by an additional instruction update unit according to an embodiment of the present invention;

FIG. 7 is a diagram illustrating an example of a search target database according to an embodiment of the present invention;

FIG. 8 is a diagram illustrating an example of a query generation instruction according to an embodiment of the present invention;

FIG. 9 is a diagram illustrating an example of a schema of a search target database according to an embodiment of the present invention;

FIG. 10 is a diagram illustrating an example of a candidate pattern for an additional instruction according to an embodiment of the present invention;

FIG. 11 is a diagram illustrating an example of an inquiry statement according to an embodiment of the present invention;

FIG. 12 is a diagram illustrating an example of a prompt according to an embodiment of the present invention;

FIG. 13 is a diagram illustrating an example of a query according to an embodiment of the present invention;

FIG. 14 is a diagram illustrating an example of a query execution result according to an embodiment of the present invention;

FIG. 15 is a diagram illustrating an example of an error log according to an embodiment of the present invention;

FIG. 16 is a diagram illustrating an example of feedback according to an embodiment of the present invention;

FIG. 17 is a diagram illustrating an example of a query history according to an embodiment of the present invention;

FIG. 18 is a diagram illustrating an example of a to-be-employed additional instruction according to an embodiment of the present invention;

FIG. 19 is a diagram illustrating an example of a chatbot screen according to an embodiment of the present invention; and

FIG. 20 is a diagram illustrating an example of a data management screen according to an embodiment of the present invention.

### DETAILED DESCRIPTION

Hereinafter, one embodiment of the present invention will be described with reference to the drawings. However, the present invention should not be construed as being limited to the following description. It will be readily understood by those skilled in the art that the specific configuration of the present invention can be modified without departing from the spirit or gist of the present invention. In the following description, one embodiment of the present invention will be referred to as “the present embodiment”.

In the configuration of the present embodiment to be described below, the same or similar components or functions will be denoted by the same reference numerals, and redundant description will be omitted.

In addition, the position, size, shape, range, and the like of each component illustrated in the drawings and the like may not represent the actual position, size, shape, range, and the like in order to facilitate understanding of the invention. Therefore, the present invention is not limited to the position, size, shape, range, and the like shown in one embodiment disclosed in the drawings and the like.

### Configuration of Additional Instruction Update System

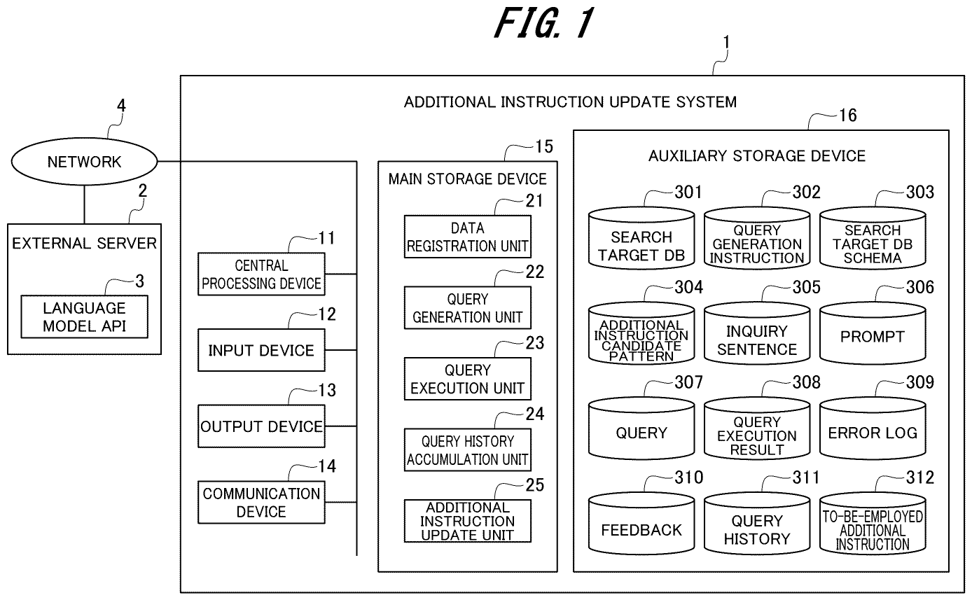

FIG. 1 illustrates a configuration of an additional instruction update system 1 of the present embodiment.

The additional instruction update system 1 in the present embodiment is a system applied to an artificial intelligence chatbot that searches a knowledge graph database storing trouble information of nuclear power-related equipment. In the following description and drawings, the database will be referred to as DB.

The additional instruction update system 1 includes a central processing device 11, an input device 12, an output device 13, a communication device 14, a main storage device 15, and an auxiliary storage device 16. The communication device 14 is connected to an external server 2 and a language model API 3 via a network 4.

The central processing device 11 is, for example, a central processing unit (CPU), and develops a program stored in a read only memory (ROM) (not illustrated) in the main storage device 15 and executes the program.

The input device 12 is a hardware device for transmitting, to the central processing device 11, instructions from a person who uses a chatbot in the additional instruction update system 1 (hereinafter referred to as “user”) and a person who manages data related to an update method (hereinafter referred to as “data manager”). The input device 12 is, for example, any of a keyboard, a mouse, and a pressure-sensitive sheet disposed on a surface of a touch panel.

The output device 13 is a hardware device that presents a result of query execution by the additional instruction update system 1 to the user and shows a data management screen to the data manager, and is, for example, a liquid crystal display. However, the input device 12 and the output device 13 may be integrally formed as, for example, a touch panel.

The communication device 14 is a communication module that performs wired or wireless communication. The main storage device 15 is a high-speed readable/writable storage device, e.g., a dual inline memory module (DIMM). The auxiliary storage device 16 is a nonvolatile storage device, e.g., a hard disk drive.

The external server 2 connected to the communication device 14 via the network 4 is provided with the language model application programming interface (API) 3. The language model API 3 is a model that, when text data is input thereto, outputs text data corresponding to the input. In addition, instead of using the language model API 3 existing in the external server 2, a language model stored in the auxiliary storage device 16 may be used.

The main storage device 15 stores a data registration unit 21, a query generation unit 22, a query execution unit 23, a query history accumulation unit 24, and an additional instruction update unit 25. These are illustrated as functional blocks that execute the functions of the additional instruction update system 1, and each functional block may be realized by an individual program, or a plurality of functional blocks may be realized by one program.

The auxiliary storage device 16 stores a search target DB 301, a query generation instruction 302, a search target DB schema 303, an additional instruction candidate pattern 304, an inquiry statement 305, a prompt 306, a query 307, and a query execution result 308.

Further, the auxiliary storage device 16 stores an error log 309, a feedback 310, a query history 311, and a to-be-employed additional instruction 312.

The search target DB 301 store data assumed to have already been constructed. The query generation instruction 302, the search target DB schema 303, and the additional instruction candidate pattern 304 are data registered by the data manager in the data registration unit 21.

The inquiry statement 305 and the feedback 310 are data input by the user. The prompt 306, the query 307, the query execution result 308, the error log 309, the query history 311, and the to-be-employed additional instruction 312 are all data acquired and generated during processing in the additional instruction update system 1 according to the present embodiment.

The data registration unit 21 stores the query generation instruction 302, the search target DB schema 303, and the additional instruction candidate pattern 304 input by the data manager in the auxiliary storage device 16.

The query generation unit 22 creates a prompt 306 using the inquiry statement 305 input by the user, the query generation instruction 302, the search target DB schema 303, and the additional instruction candidate pattern 304.

Then, the query generation unit 22 inputs the prompt 306 to the language model API 3 to acquire a query 307, and stores the acquired query 307 in the auxiliary storage device 16.

The query execution unit 23 executes the query 307 with respect to the search target DB 301, and stores a query execution result 308 in the auxiliary storage device 16 if the query 307 is normally executed. In addition, if the query 307 is not normally executed, the query execution unit 23 acquires an error log 309 and stores the error log 309 in the auxiliary storage device 16.

The query history accumulation unit 24 stores the feedback 310 input by the user, the prompt 306, the query 307, the query execution result 308, and the error log 309 in the auxiliary storage device 16 as a query history 311 that is data associated by identification information such as an ID.

The additional instruction update unit 25 quantitatively evaluates the additional instruction candidate pattern 304 using the query history 311, determines a to-be-employed additional instruction 312, and stores the determined employed additional instruction 312 in the auxiliary storage device 16.

### Explanation of Terms

The additional instruction update method according to the present embodiment is a method of performing processing for acquiring an answer to the inquiry statement 305 input by the user by searching the search target DB 301 and presenting the answer to the user.

The search target DB 301 is a database managed by a database management system, and is a knowledge graph DB storing trouble information of nuclear power-related equipment in the present embodiment.

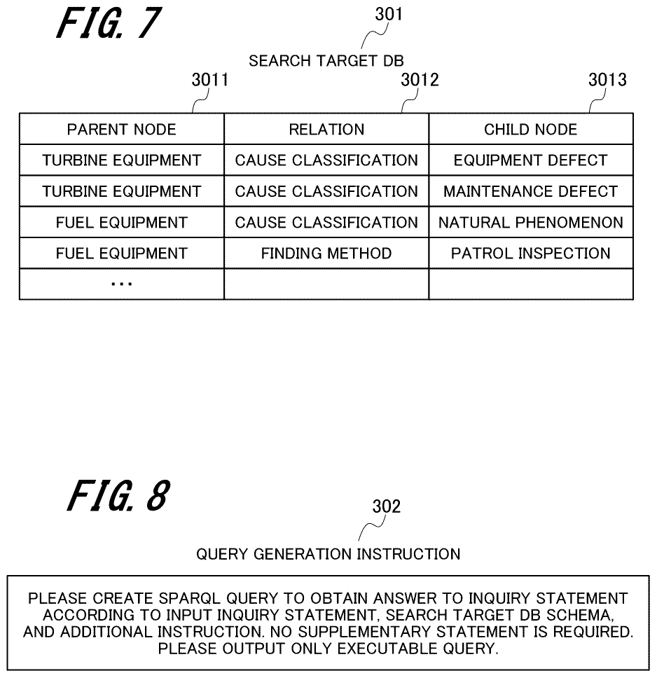

The search target DB 301 is, for example, data managed by some kind of database management software as illustrated in FIG. 7, which will be described later. It is assumed here that the database management software includes a query execution engine and a function of outputting an error statement when an error occurs during query execution. The query execution engine is an engine (calculation function) that obtains an execution result when a query is input as text.

An example of the inquiry statement 305 is “Tell me all cause classifications assigned to past turbine instrument fault reports”. As an answer, it is sufficient that a list of cause classifications (e.g., equipment defect and maintenance defect) of turbine instrument failures contained in the search target DB 301 is shown to the user in a table format or the like as the query execution result 308. Therefore, it is necessary to prepare the query 307 for the search target DB 301.

The query 307 refers to a DB query, is a text written in a query language corresponding to the search target DB 301, such as SPARQL or SQL. In the present embodiment, the query 307 is automatically generated using the language model API 3. The language model API 3 has already learned the features of the query language. By inputting the query generation instruction 302 and the inquiry statement 305 to the language model API 3, the language model API 3 can convert the inquiry statement into a query 307.

The query generation instruction 302 is a text that specifies the query language and describes cautions to be taken to conform to the language model. For example, the query generation instruction 302 is a text such as “Generate an SPARQL query that answers the input inquiry statement in an executable form (without a supplementary statement)”.

In the present embodiment, not only the query generation instruction 302 and the inquiry statement 305 but also the search target DB schema 303 and the to-be-employed additional instruction 312 are input to the language model API 3.

The search target DB schema 303 is a text defining the structure information of the search target DB 301, and is, for example, data expressing information such as “A turbine instrument has a field of cause classification”.

The to-be-employed additional instruction 312 is an additional instruction statement employed by the additional instruction update unit 25, and is a text in which information about errors during query execution or search errors that have occurred so far and instructions for improvement is written. For example, in the to-be-employed additional instruction 312, a query execution error message and an estimated cause/a proposal for improvement inferred by the language model are written.

In the present embodiment, the query generation instruction 302, the inquiry statement 305, the search target DB schema 303, and the to-be-employed additional instruction 312 collected in one text file are called a prompt 306. By inputting the prompt 306 to the language model API 3, a query 307 is obtained based on the described instructions and information. Then, by executing the query 307 with respect to the search target DB 301, a query execution result 308 is obtained. Thereafter, an error log 309 during query execution and feedback 310 on the query execution result 308 from the user are obtained.

The feedback 310 can be negative or positive, and a qualitative evaluation such as “the result is partially or entirely erroneous” is described. The additional instruction update unit 25 performs a quantitative evaluation to determine a to-be-employed additional instruction 312, thereby employing an additional instruction according to the feedback 310 and reflecting the feedback 310 in the next and subsequent inquiries.

Data to be passed to the additional instruction update unit 25 is defined as an additional instruction candidate pattern 304 and a query history 311.

The additional instruction candidate pattern 304 is a file that is pre-registered by the data manager and defines an additional instruction pattern. The additional instruction candidate pattern 304 defines a condition for addition and a template for an additional instruction. For example, as the additional instruction candidate pattern 304, for a condition “an occurrence of a query error”, a template “query 307 +error log 309 +estimated cause of error and proposal for improvement” for resolving the error is prepared, and a to-be-employed additional instruction 312 is created in accordance with the template.

The query history 311 is data for handling the prompt 306, the query 307, the query execution result 308, the error log 309, and the feedback 310 in association with each other by an ID, and is not data for handling new information.

### Processing Operation of Additional Instruction Update System

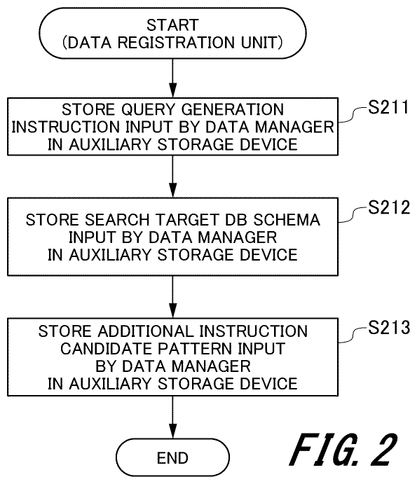

Next, a processing operation of each processing unit stored in the main storage device 15 will be described with reference to FIGS. 2 to 6.

FIG. 2 is a flowchart illustrating data registration processing performed by the data registration unit 21.

The data registration unit 21 first stores a query generation instruction 302 input to a portion D21 for setting a query generation instruction of a data management screen D2 by the data manager in the auxiliary storage device 16 (step S211).

Next, the data registration unit 21 stores a search target DB schema 303 input to a portion D22 for setting a search target DB schema of the data management screen D2 by the data manager in the auxiliary storage device 16 (step S212).

Lastly, the data registration unit 21 stores an additional instruction candidate pattern 304 input to a portion D23 for setting an additional instruction candidate pattern of the data management screen D2 by the data manager in the auxiliary storage device 16 (step S213), and ends the processing illustrated in FIG. 2.

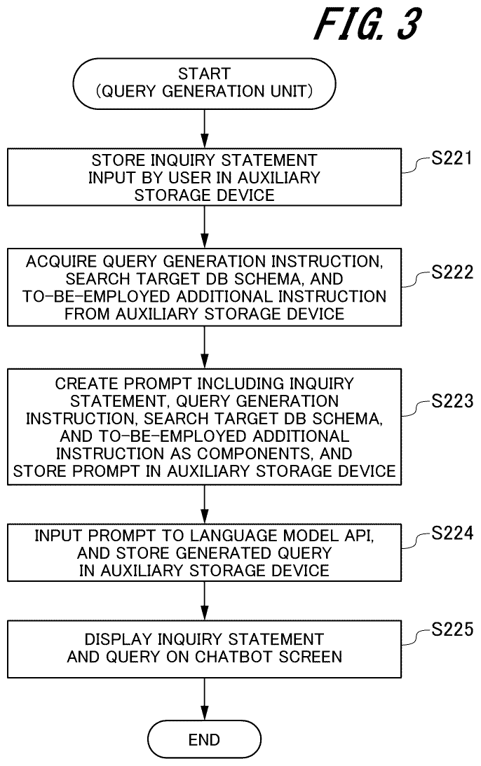

FIG. 3 is a flowchart illustrating query generation processing performed by the query generation unit 22.

The query generation unit 22 first stores an inquiry statement 305 input by the user in the auxiliary storage device 16 (step S221).

Next, the query generation unit 22 acquires the query generation instruction 302, the search target DB schema 303, and the to-be-employed additional instruction 312 from the auxiliary storage device 16 (step S222). However, a case where the to-be-employed additional instruction 312 does not exist (is empty) is also conceivable.

Next, the query generation unit 22 creates a prompt 306 by collecting the inquiry statement 305, the query generation instruction 302, the search target DB schema 303, and the to-be-employed additional instruction 312 in one text file, and stores the prompt 306 in the auxiliary storage device 16 (step S223). The prompt 306 is, for example, a collected text as illustrated in FIG. 10, which will be described later.

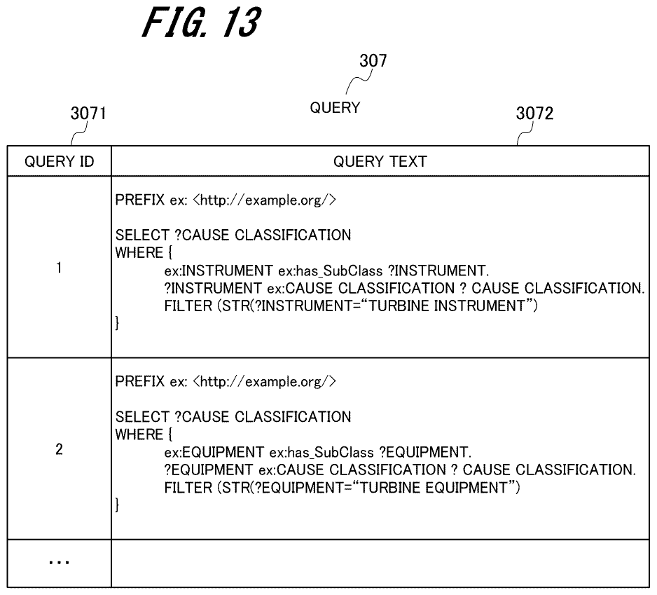

Next, the query generation unit 22 inputs the prompt 306 to the language model API 3 to obtain a query 307 (step S224). The language model API 3 generates the query 307 by interpreting the inquiry statement 305 described in the prompt 306 according to the query generation instruction 302. For example, as illustrated in FIG. 13 to be described below, an SPAQL query for searching for a cause classification for a turbine instrument is generated.

Lastly, the query generation unit 22 displays the inquiry statement 305 in a portion D11 of a chatbot screen D1 and displays the query 307 in a portion D12, and ends the processing illustrated in FIG. 3 (step S225).

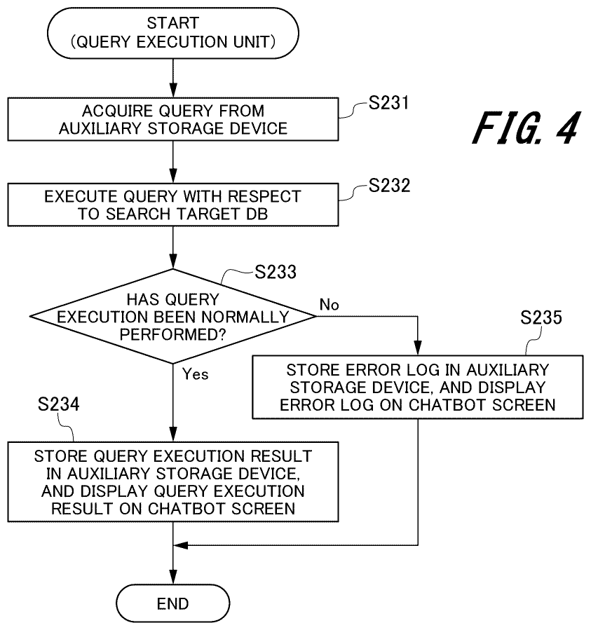

FIG. 4 is a flowchart illustrating query execution processing performed by the query execution unit 23.

The query execution unit 23 first acquires the query 307 from the auxiliary storage device 16 (step S231).

Next, the query execution unit 23 executes the query 307 with respect to the search target DB 301 (step S232).

Next, the query execution unit 23 determines whether the query execution has been normally performed (step S233). When the query execution has been normally performed in step S233 (Yes in step S233), the query execution unit 23 acquires a query execution result 308, stores the query execution result 308 in the auxiliary storage device 16, and then displays the query execution result 308 in a portion D13 of the chatbot screen D1 (step S234). Accordingly, the processing illustrated in FIG. 4 is ended.

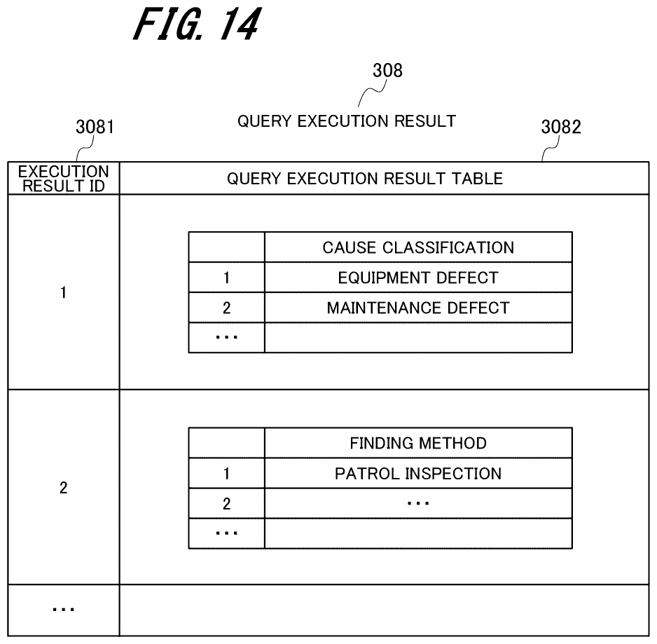

The query execution result 308 is data as illustrated in FIG. 14, which will be described later. The query execution result 308 is data returned from the search target DB 301 in the form of text that can be expressed in a table format, for example, in a csv format or in a json format.

In order to display the query execution result 308 on the chatbot screen D1 in the table format, the query execution unit 23 performs processing of conversion into a markup language or the like using a program that implements a certain algorithm. For example, csv is converted into table data of HTML.

In addition, when the query execution has not been normally performed in step S233 (No in step S233), the query execution unit 23 acquires an error log 309, stores the error log 309 in the auxiliary storage device 16, and then displays the error log 309 in the portion D11 of the chatbot screen D1 (step S235). As a result, the query execution unit 23 ends the processing illustrated in FIG. 4.

FIG. 5 is a flowchart illustrating query history accumulation processing performed by the query history accumulation unit 24.

The query history accumulation unit 24 first stores feedback 310 input by the user in the auxiliary storage device 16 (step S241). The feedback 310 is feedback as illustrated in FIG. 16, which will be described later, and details of the data and the method of acquiring the data will be described later.

Next, the query history accumulation unit 24 acquires the prompt 306, the query 307, the query execution result 308, and the error log 309 stored in the auxiliary storage device 16 (step S242).

Then, the query history accumulation unit 24 creates a query history 311, which is data in which the prompt 306, the query 307, the query execution result 308, the error log 309, and the feedback 310 are associated with each other by an ID, and stores the created query history 311 in the auxiliary storage device 16 (step S243). As a result, the query history accumulation unit 24 ends the processing illustrated in FIG. 5. The query history 311 is data as illustrated in FIG. 17, which will be described in detail later.

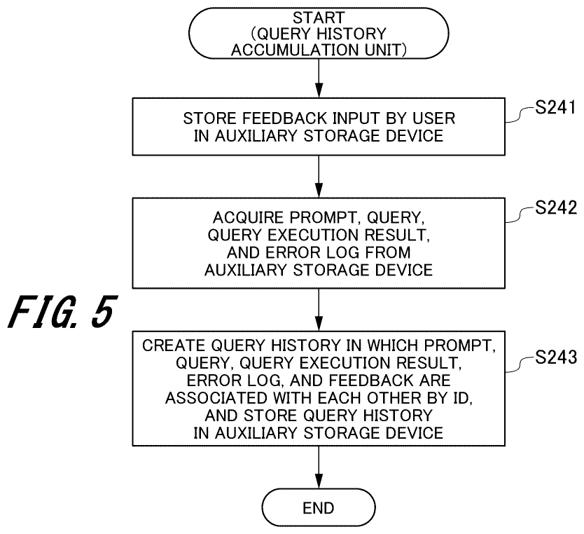

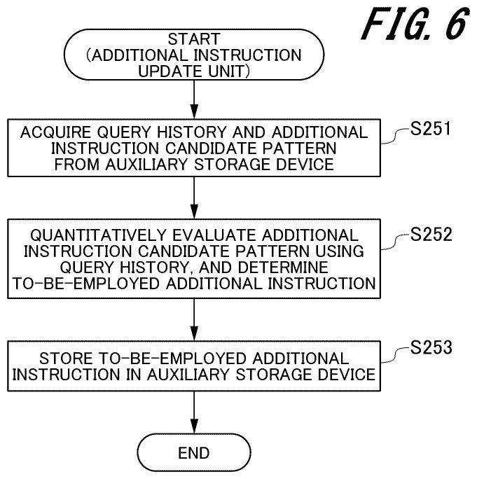

FIG. 6 is a flowchart illustrating an operation of the additional instruction update unit 25.

The additional instruction update unit 25 first acquires the query history 311 and the additional instruction candidate pattern 304 from the auxiliary storage device 16 (step S251). The additional instruction candidate pattern 304 is data as illustrated in FIG. 10, which will be described in detail later.

Next, the additional instruction update unit 25 quantitatively evaluates candidates included in the additional instruction candidate pattern 304 one by one using the query history 311, and determines an instruction to be added to the to-be-employed additional instruction 312 (step S252).

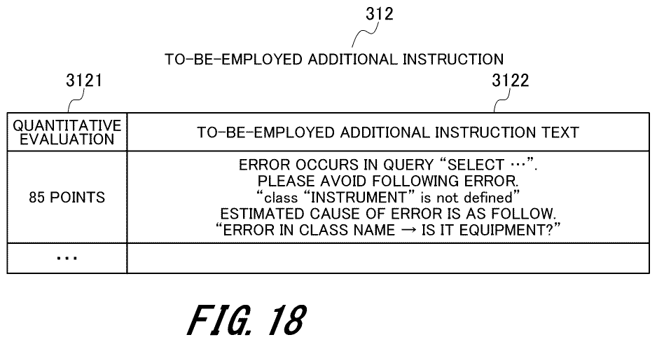

The to-be-employed additional instruction 312 is data as illustrated in FIG. 18, which will be described in detail later. The quantitative evaluation method involves acquiring a certain score with the query history 311 as an input, and determining whether to employ the instruction depending on whether the score exceeds a certain threshold.

Examples of the method include determination using a program that implements a certain algorithm, determination using a language model, and the like.

For example, the additional instruction update unit 25 evaluates whether the feedback 310 included in the query history 311 is positive or negative using a program that calculates a degree of matching a predefined positive or negative keyword. Alternatively, the additional instruction update unit 25 inputs feedback to the language model and determines whether to employ the instruction together with the score. At that time, the additional instruction update unit 25 does not necessarily need to use all the information included in the query history 311 for quantitative evaluation, and may limit the information to be referred to depending on the additional instruction candidate pattern 304.

Lastly, the additional instruction update unit 25 stores the to-be-employed additional instruction 312 in the auxiliary storage device 16 (step S253), and ends the processing illustrated in FIG. 6.

### Data Configuration

Next, data stored in the auxiliary storage device 16 will be described with reference to FIGS. 7 to 18.

FIG. 7 is a diagram illustrating an example of the search target DB 301 in the present embodiment.

The search target DB 301 is a knowledge graph DB (a DB in a graph format) in which three points, a parent node 3011, a relation 3012, and a child node 3013, are set as one record. For example, a parent node “turbine equipment” is connected to child nodes “equipment defect” and “maintenance defect” in a relation “cause classification”. This data indicates that past turbine equipment failure reports include an equipment defect case and a maintenance defect case.

By designating the parent node name and the relation, the user inquires about what cases exist in the past failure reports. In the present embodiment, it is assumed that the search target DB has been constructed in advance.

FIG. 8 is a diagram illustrating an example of the query generation instruction 302 in the present embodiment.

The query generation instruction 302 is an instruction for causing the language model to generate a query 307.

The query generation instruction 302 mainly contains the type of query language and a caution to be taken to conform to the language model when generating a query. In the present embodiment, SPARQL, which is a query language for a knowledge graph, is designated as a query language, and a caution that an unnecessary supplementary statement is not added when the query is executed is described.

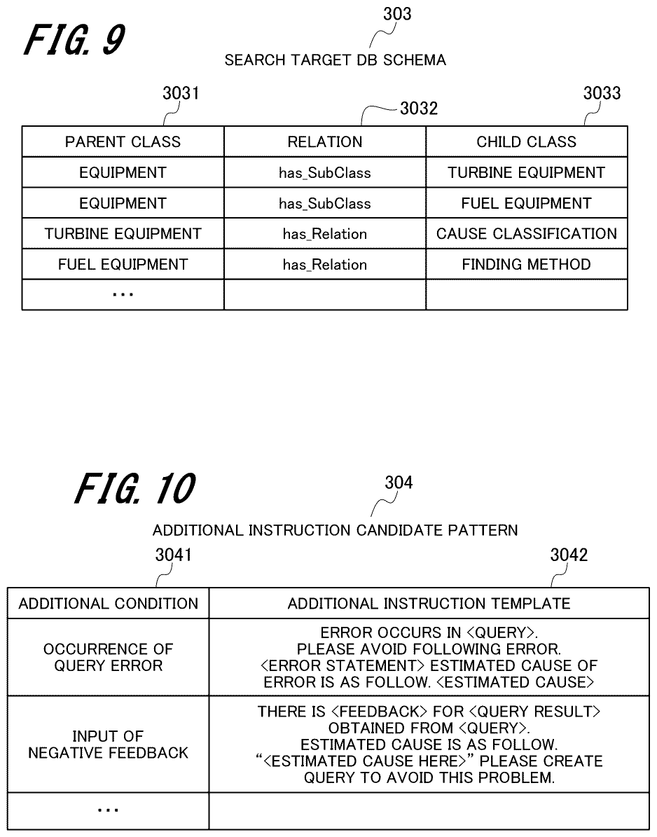

FIG. 9 is a diagram illustrating an example of the search target DB schema 303 in the present embodiment.

The search target DB schema 303 is a schema in which three points, a parent class 3031, a relation 3032, and a child class 3033, are set as one record.

For example, a parent class “turbine equipment” is connected to a child class “cause classification” in a relation “has_Relation”. This indicates that it is possible to search for the cause classification for the turbine equipment (failure report). As a result, a file describing an instance of a knowledge graph is used as an input.

FIG. 10 is a diagram illustrating an example of the additional instruction candidate pattern 304 in the present embodiment.

The additional instruction candidate pattern 304 includes an additional condition 3041 and an additional instruction template 3042. In the additional condition 3041, for example, a genre of a problem to be solved, such as “occurrence of query error”, is written.

In the additional instruction template 3042, a template for an additional instruction for solving a problem is written. For example, an error log 309 and an estimated cause thereof are written.

FIG. 11 is a diagram illustrating an example of the inquiry statement 305 in the present embodiment.

The inquiry statement 305 includes an inquiry ID 3051 and an inquiry statement text 3052. The inquiry statement text 3052 is a statement requesting a certain search result such as “Tell me . . . ”. That is, with a file defining the ontology of the knowledge graph as an input, the ontology is described as information that can be understood by the computer in a prompt that is an inquiry statement.

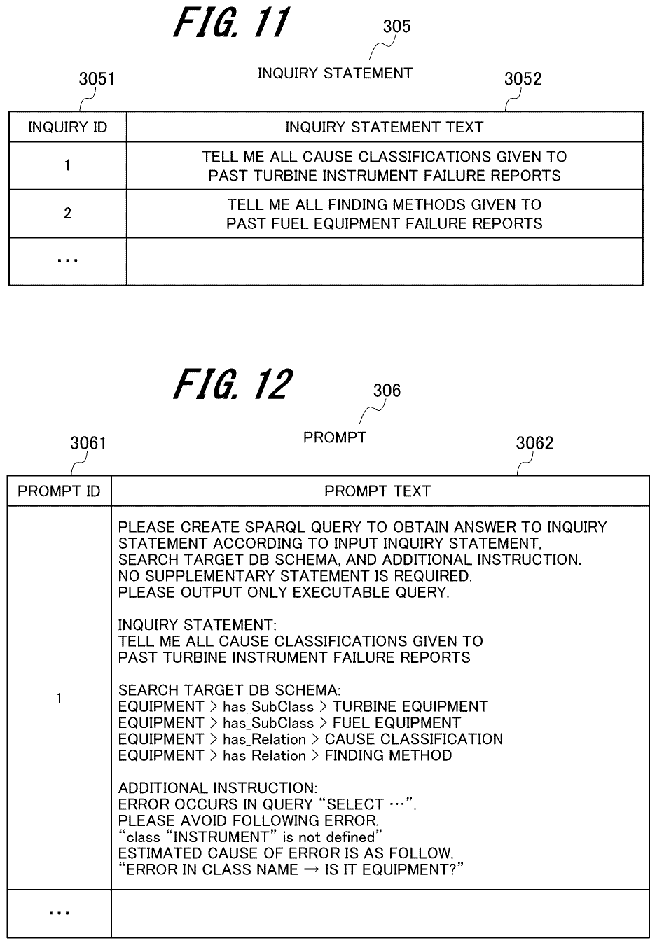

FIG. 12 is a diagram illustrating an example of the prompt 306 in the present embodiment.

The prompt 306 includes a prompt ID 3061 and a prompt text 3062. The prompt text 3062 includes one text obtained by collecting the query generation instruction 302, the search target DB schema 303, the inquiry statement 305, and the to-be-employed additional instruction 312, all of which have been converted into texts.

FIG. 13 is a diagram illustrating an example of the query 307 in the present embodiment.

The query 307 includes a query ID 3071 and a query text 3072. The query text 3072 is a text that can be directly input to the search target DB 301 and executed in the query execution unit 23. In the present embodiment, the query text 3072 is an SPARQL query that is a search query for a knowledge graph.

FIG. 14 is a diagram illustrating an example of the query execution result 308 in the present embodiment.

The query execution result 308 includes an execution result ID 3081 and a query execution result table 3082. The query execution result table 3082 is a result of executing the query text 3072 with respect to the search target DB 301, and it can be seen that data designated as the search target is expressed in a table format, and for example, “equipment defect” or “maintenance defect” is retrieved as the cause classification.

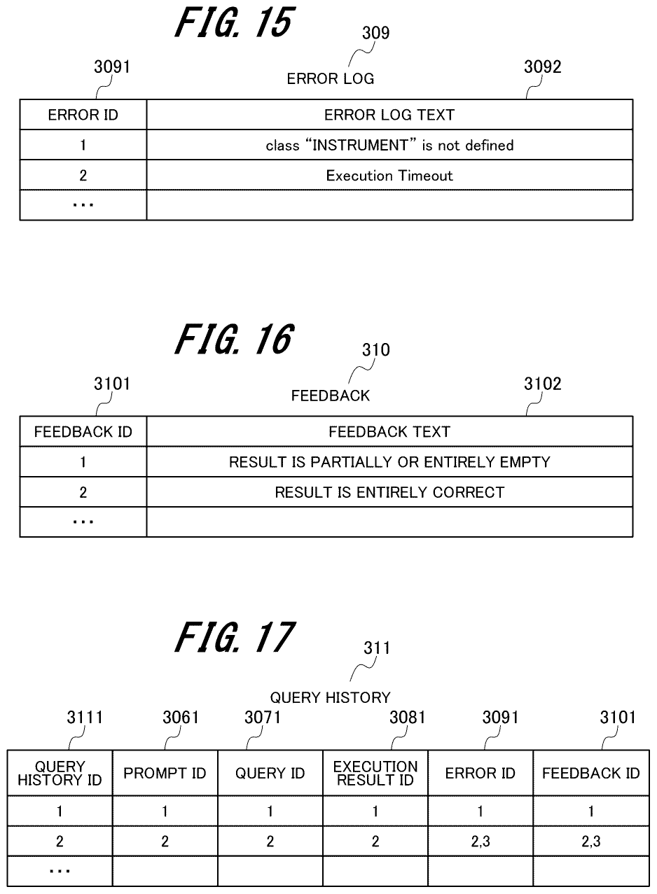

FIG. 15 is a diagram illustrating an example of the error log 309 in the present embodiment.

The error log 309 includes an error ID 3091 and an error log text 3092.

The error log text 3092 is a text expressing an error that has occurred during query execution, and for example, an error “class “instrument” is not defined” indicates that the search has not been normally performed because the class “instrument” does not exist in the search target DB 301.

FIG. 16 is a diagram illustrating an example of the feedback 310 in the present embodiment.

The feedback 310 includes a feedback ID 3101 and a feedback text 3102. The feedback text 3102 is feedback input by the user, and for example, feedback “the result is partially or entirely empty” indicates feedback that the query execution result 308 included empty data.

FIG. 17 is a diagram illustrating an example of the query history 311 in the present embodiment.

The query history 311 includes a query history ID 3111, a prompt ID 3061, a query ID 3071, an execution result ID 3081, an error ID 3091, and a feedback ID 3101. The query history 311 does not hold new data but is data for associating various types of data with each other by an ID. The additional instruction update unit 205 acquires other data by tracing IDs of other data for each query history ID 3111 via access to the query history 311.

FIG. 18 is a diagram illustrating an example of the to-be-employed additional instruction 312 in the present embodiment.

The to-be-employed additional instruction 312 includes a quantitative evaluation 3121 and a to-be-employed additional instruction text 3122. The quantitative evaluation 3121 is obtained by a program implementing a certain algorithm, a language model, a score returned by a system in another server, and the like. The additional instruction update unit 25 determines whether to employ the additional instruction candidate pattern 304 depending on whether the quantitative evaluation exceeds a certain value by any method. The to-be-employed additional instruction text 3122 is a statement embodying the additional instruction template 3042, and describes an error occurrence statement and an estimated error cause. That is, when updating an additional instruction, a file defining an additional instruction candidate pattern may be input, and a quantitative evaluation as to whether to employ the additional instruction candidate pattern may be determined based on the quantitative evaluation returned by the language model.

### Screens Presented to User and Data Manager

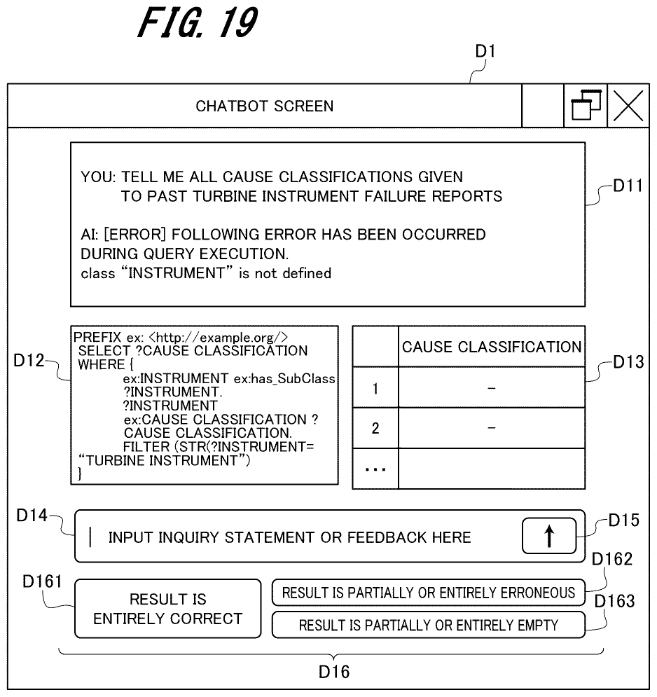

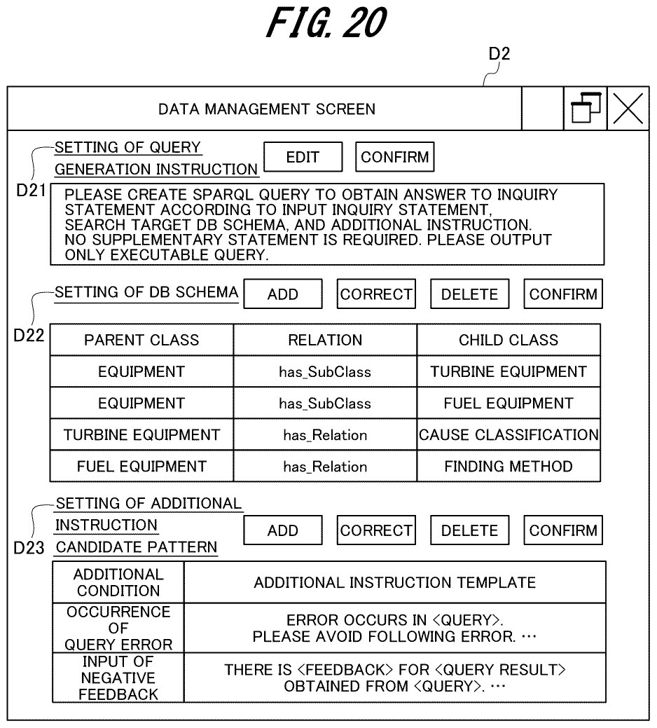

Next, screens presented to the user and the data manager will be described with reference to FIGS. 19 and 20. These screens displayed on terminals are configured as so-called user interface (UI) screens that present information and receives button operations and the like on the screens.

FIG. 19 is a diagram illustrating a chatbot screen presented by the additional instruction update method in the present embodiment.

The screen D1 illustrated in FIG. 19 is a chatbot screen presented to the user, and is displayed on the output device 13.

A display area D11 is a portion where the inquiry statement 305 and the error log 309 are output.

A display area D12 is a portion where the query 307 generated by the query generation unit 22 is output.

A display area D13 is a portion where the query execution result 308 acquired by the query execution unit 23 is output. A display area D14 is a text input box in which the user inputs an inquiry statement 305 and a free-form feedback 310.

A button D15 is a button for transmitting the text input in the display area D14. A button D16 is a button for the user to input a fixed form of feedback 310. For example, a button D161 “the result is entirely correct”, a button D162 “the result is partially or entirely erroneous”, and a button D163 “the result is partially or entirely empty” are provided on the screen, and any one of the buttons is pressed by the user, so that a statement written on the pressed button among the buttons D161 to D163 is transmitted as the feedback 310. The number of buttons and statements of the button D16 may be changed.

The user's terminal can transmit the feedback 310 after the query execution result 308 is displayed in the display area D13. Furthermore, it is also possible to reload the chatbot screen and make a next inquiry without transmitting the feedback 310. However, the feedback 310 cannot be transmitted in a state where the query execution result 308 is not displayed in the display area D13.

Note that the screen illustrated in FIG. 19 is an example, and other screens may be displayed. In other words, a log corresponding to an execution failure due to a grammatical error of the generated query, and a log corresponding to an execution failure due to a query timeout may be displayed as an error log during query execution. Alternatively, a log corresponding to an execution failure due to a mismatch between the schema stored in the search target database and the schema specified by the query may be displayed as an error log during query execution.

Furthermore, as the feedback on the screen illustrated in FIG. 19, the feedback may indicate that the query execution result is entirely correct, or the feedback may indicate that the query execution result is partially or entirely erroneous. Alternatively, as the feedback, the feedback may indicate that the query execution result is partially or entirely empty.

FIG. 20 is a diagram illustrating a data management screen D2 presented by the additional instruction update method in the present embodiment.

The data management screen D2 is a data management screen presented to the data manager, and is displayed on the output device 13. A display area D21 is a portion for setting the query generation instruction 302 presented to the data manager, and the query generation instruction 302 can be set by editing and confirming operations.

A display area D22 is a portion for setting the search target DB schema 303 presented to the data manager, and the search target DB schema 303 can be set by adding, correcting, deleting and confirming operations.

A display area D23 is a portion for setting the additional instruction candidate pattern 304 presented to the data manager, and the additional instruction candidate pattern 304 can be set by adding, correcting, deleting and confirming operations.

### Effects of Present Embodiment

As described above, in the additional instruction update method of the present embodiment, the quantitative evaluation of the additional instruction candidate pattern 304 is performed using the query history 311 stored in the query history accumulation unit 24, and the to-be-employed additional instruction 312 included in the prompt 306 is rewritten. The query history 311 includes a prompt 306, a query 307, a query execution result 308, an error log 309, and a feedback 310. With such a configuration of the present embodiment, the following effects can be expected.

(1) By updating the additional instruction based on the error log 309 and the feedback 310, even if an error occurs during query execution or an error occurs in the query result, it can be expected that this problem is solved. In particular, with the configuration in which the accumulated query history 311 is referred to and the additional instruction is updated each time according to the additional instruction candidate pattern 304, it can be expected that the accuracy of query generation in the next and subsequent inquiries is increased, in addition to increasing the accuracy of query generation each time.

(2) Since the qualitative feedback 310 is quantitatively evaluated to determine whether to employ the additional instruction candidate pattern 304, it can be expected that the generation of the query and the answer to the inquiry with higher user evaluation are achieved, in addition to simple error correction and the like.

(3) Since the prompt 306 includes a search target DB schema 303, it can be expected that a query is generated while eliminating a notation difference between a vocabulary defined in the search target DB schema and a vocabulary included in the inquiry statement 305 from the user. For example, by giving dictionary data defining synonyms to the language model in advance, it can be expected that notation variations such as “instrument” and “equipment” are controlled, and a query using a vocabulary included in the search target DB schema is easily generated.

### Modification

Note that the embodiment described so far has been described in detail in order to explain the present invention in an easy-to-understand manner, and is not necessarily limited to one having all of the configurations described above.

In addition, in the configuration diagram illustrated in FIG. 1, only control lines and information lines considered to be necessary for explanation are shown, and not all control lines and information lines on a product are necessarily shown. In practice, it may be considered that almost all of the components are connected to each other. In addition, the additional instruction update system 1 illustrated in FIG. 1 may execute the processing in a distributed manner by a plurality of devices, rather than executing all of the processing by one device.

Furthermore, the flowcharts illustrated in FIGS. 2 to 6 are also examples, and the order of some of the processing may be changed, or a plurality of processing stages may be executed simultaneously as long as the processing results are the same.

In addition, the additional instruction update system 1 described in the above-described embodiment is configured by implementing a program that executes the processing illustrated in the flowcharts of FIGS. 2 to 6, and the program in this case is prepared in the auxiliary storage device 16 or the like in a computer serving as the additional instruction update system 1 illustrated in FIG. 1. Alternatively, the program executed by a computer serving as the additional instruction update system 1 illustrated in FIG. 1 may be stored on a recording medium such as an external memory, an IC card, an SD card, or an optical disk, and transferred to the computer that functions as the additional instruction update system 1.

What is claimed is:

1. A method for updating an additional instruction described in a prompt in generating a query using a language model, the method comprising:
data registration processing of pre-registering a query generation instruction, a schema of a search target database, and a candidate pattern for the additional instruction for creating the prompt;
query generation processing of generating the query by inputting the prompt to the language model;
query execution processing of executing the query with respect to the search target database to acquire a query execution result and an error log;
query history accumulation processing of acquiring feedback for the query execution result, and accumulating a query history in which the prompt, the query, the query execution result, the error log, and the feedback are associated with each other by identification information; and
additional instruction update processing of updating the additional instruction by determining whether to describe the candidate pattern in the prompt using the query history.

2. The method according to claim 1, wherein
the search target database is expressed by a knowledge graph,
the query is a query for the knowledge graph, and
the prompt includes information about a structure and a grammar specific to the knowledge graph.

3. The method according to claim 2, further comprising:
processing of describing ontology of the knowledge graph in the prompt, with a file defining the ontology of the knowledge graph as an input.

4. The method according to claim 3, further comprising:
processing of describing an instance of the knowledge graph in the prompt, with a file describing the instance of the knowledge graph as an input.

5. The method according to claim 1, wherein
the error log during the execution of the query includes any of a log corresponding to an execution failure due to a grammatical error in the generated query, a log corresponding to an execution failure due to a query timeout, and a log corresponding to an execution failure due to a mismatch between a schema stored in the search target database and a schema specified by the query.

6. The method according to claim 1, wherein
the feedback includes any of feedback indicating that the query execution result is entirely correct, feedback indicating that the query execution result is partially or entirely erroneous, and feedback indicating that the query execution result is partially or entirely empty.

7. The method according to claim 6, wherein
a button corresponding to the feedback indicating that the query execution result is entirely correct, the feedback indicating that the query execution result is partially or entirely erroneous, and the feedback indicating that the query execution result is partially or entirely empty is displayed on a screen, so that a user is allowed to input the feedback by performing a selection operation on the button.

8. The method according to claim 7, wherein
in addition to the button, a text input box is displayed on the screen so that the user is allowed to input the feedback by writing a free-form statement in the text input box.

9. The method according to claim 2, wherein
when updating the additional instruction, a file defining the candidate pattern for the additional instruction is input, and a quantitative evaluation as to whether to employ the candidate pattern for the additional instruction is determined by a program implementing a certain algorithm.

10. The method according to claim 2, wherein
when updating the additional instruction, a file defining the candidate pattern for the additional instruction is input, and a quantitative evaluation as to whether to employ the candidate pattern for the additional instruction is determined based on a quantitative evaluation returned by the language model.

11. A system for updating an additional instruction described in a prompt in generating a query using a language model, the system comprising:
a data registration unit configured to pre-register a query generation instruction, a schema of a search target database, and a candidate pattern for the additional instruction for creating the prompt;
a query generation unit configured to generate the query by inputting the prompt to the language model;
a query execution unit configured to execute the query with respect to the search target database to acquire a query execution result and an error log;
a query history accumulation unit configured to acquire feedback for the query execution result, and accumulate a query history in which the prompt, the query, the query execution result, the error log, and the feedback are associated with each other by identification information; and
an additional instruction update unit configured to update the additional instruction by determining whether to describe the candidate pattern in the prompt using the query history.
